(19) United States
(12) Patent Application Publication
(10) Pub. No.: US 2013/0299085 A1
(43) Pub. Date: Nov. 14, 2013

(54) LAMINATING APPARATUS AND LAMINATING METHOD

(71) Applicant: S&B CO., LTD., Gyeongju-si (KR)

(72) Inventor: Seoung Jee LEE, Gyeongju-si (KR)

(73) Assignee: S&B CO., LTD, Gyeongju-si (KR)

(21) Appl. No.: 13/834,949

(22) Filed: Mar. 15, 2013

(30) Foreign Application Priority Data
May 11, 2012 (KR) 10-2012-0050317

(51) Int. Cl. B32B 37/02

(52) U.S. Cl. CPC B32B 37/02
USPC 156/308.2; 156/556; 156/499

(57) ABSTRACT

Provided is a laminating apparatus including: a conveyor belt where a plurality of first through holes are formed; an interleaving paper supply unit including an interleaving paper supply roller for supplying an interleaving paper and an interleaving paper recovery roller for recovering the interleaving paper, and disposing the interleaving paper on the conveyor belt; an suction unit taking air in through the plurality of first through holes; and a sponge supply unit supplying a sponge to an operation target on the conveyor belt, wherein a laminating operation target is disposed on the interleaving paper. Accordingly, laminating may be performed on a material having an irregular area and an irregular shape, such as a genuine leather, and a sponge may be prevented from adhering to a laminating roller during a laminating operation.

### TECHNICAL FIELD

The present invention relates to a laminating apparatus and a laminating method, and more particularly, to a laminating apparatus and a laminating method capable of performing laminating on a genuine leather, a fabric, an artificial leather, or the like, which has an irregular standard like an irregular area or an irregular size.

### BACKGROUND ART

Generally, laminating means that same or different types of papers, films, fabrics, or the like are laminated by using an adhesive resin and heat.

Korean Patent Publication No. 1996-0017143 discloses ‘a method of manufacturing a sheet cover for vehicles’.

Here, a hot melt is coated on a sponge and dried, and then is pressurized with a cut is genuine leather in a heating furnace for adhesion.

Korean Utility Model Registration No. 20-0346633 discloses ‘a laminating apparatus for a vehicle sheet’.

Here, when a surface of a sponge is melted by gas flames, the surface turns to a liquefied adhesive, and the sponge is adhered to a fabric or an artificial leather by pressurizing a pair of rollers to a rear surface of the fabric or the artificial leather.

Such a technology may be easily performed when laminating is performed on materials having regular standards, i.e., regular sizes and areas, such as fabrics or artificial leathers.

However, when laminating is performed on materials having irregular standards (sizes, areas, or the like), such as genuine leathers, it is difficult to selectively perform laminating only on genuine leathers. In other words, a melted sponge is adhered to a leatherless region of a conveyor belt where a roller or a genuine leather is disposed, and thus a laminating operation cannot be continuously performed unless the adhered sponge is removed.

Accordingly, a sponge that has been cut to the same shape as a genuine leather that is to be laminated is overlapped with the genuine leather, and then the sponge is adhered to the genuine leather by sewing an edge of the sponge.

When the laminating is performed according to the above technology, a leather and a sponge may be spaced apart from each other due to different elongations and restorations, and the quality of the leather may be deteriorated due to wrinkle generation, epidermal injury, or the like.

Also, since a shape and area of a genuine leather is irregular, it takes a lot of time and efforts to cut and sew a sponge in the same shape as the genuine leather, and thus overall operations are deteriorated.

Accordingly, a technology of performing laminating by cutting genuine leathers to a certain size and then connecting the cut genuine leathers has been disclosed.

However, at this time, the amount of genuine leathers thrown out via the cutting is large, and thus production costs are increased.

Also, a separate apparatus is required to perform laminating on a material having an irregular standard and a material having a regular standard.

### DETAILED DESCRIPTION OF THE INVENTION

### Technical Problem

The present invention provides a laminating apparatus and a laminating method capable of performing laminating on a genuine leather, a fabric, an artificial leather, or the like, which has an irregular standard (including an irregular area or an irregular size).

The present invention also provides a laminating apparatus and a laminating method capable of preventing a sponge melted by heat from adhering to a laminating roller during a laminating operation.

The present invention also provides a laminating apparatus and a laminating method capable of performing laminating on a material having an irregular standard and a material having a regular standard.

### Technical Solution

According to an aspect of the present invention, there is provided a laminating apparatus including: a conveyor belt where a plurality of first through holes are formed; an interleaving paper supply unit including an interleaving paper supply roller for supplying an interleaving paper and an interleaving paper recovery roller for recovering the interleaving paper, and disposing the interleaving paper on the conveyor belt; an suction unit taking air in through the plurality of first through holes; and a sponge supply unit supplying a sponge to an operation target on the conveyor belt, wherein a laminating operation target is disposed on the interleaving paper.

The interleaving paper may be a nonwoven fabric or a vinyl tape including a plurality of second through holes.

Diameters of the plurality of second through holes may be smaller than diameters of the plurality of first through holes.

A separation distance between the plurality of second through holes may be smaller than a separation distance between the plurality of first through holes.

The suction unit may include: an air intake fan; a motor operating the air intake fan;

and a hopper closely disposed to a bottom surface of the conveyor belt so that air intake through the air intake fan is easily performed.

A width of an inlet of the hopper may correspond to a width of the conveyor belt.

The sponge supply unit may include: a sponge supply roller supplying the sponge is and recovering the sponge that has been used; a heating unit supplying heat to the sponge so that a surface of the sponge is melted; and a pressurizing roller adhering the sponge having the melted surface to the operation target.

The supplied sponge may be recovered by the interleaving paper recovery roller.

According to another aspect of the present invention, there is provided a laminating method including: disposing an interleaving paper on a conveyor belt; disposing a laminating operation target on the interleaving paper; taking air in so that the laminating operation target, the interleaving paper, and the conveyor belt are adhered to each other; driving the conveyor belt; melting a part of a sponge and laminating the laminating operation target by supplying the melted part of the sponge to a surface of the laminating operation target; and recovering each of the interleaving paper, an un-melted part of the sponge, and the laminated the laminating operation target.

### Advantageous Effects

According to the present invention, laminating can be performed on a genuine leather, a fabric, an artificial leather, or the like, which has an irregular standard like an irregular area or an irregular size.

Also, a sponge melted by heat can be prevented from adhering to a laminating roller during a laminating operation.

Further, laminating can be performed on a material having an irregular standard and a material having a regular standard.

### DESCRIPTION OF THE DRAWINGS

FIG. 1 is a lateral view illustrating a structure of a laminating apparatus according to an embodiment of the present invention;

FIG. 2 is a view of genuine leathers disposed on a conveyor belt, according to an embodiment of the present invention;

FIG. 3 is a view illustrating a structure of an suction unit of FIG. 1; and

FIG. 4 is a view illustrating a structure of a sponge supply unit of FIG. 1.

### MODE OF THE INVENTION

Hereinafter, one or more exemplary embodiments of the present invention will be described in detail with reference accompanying drawings.

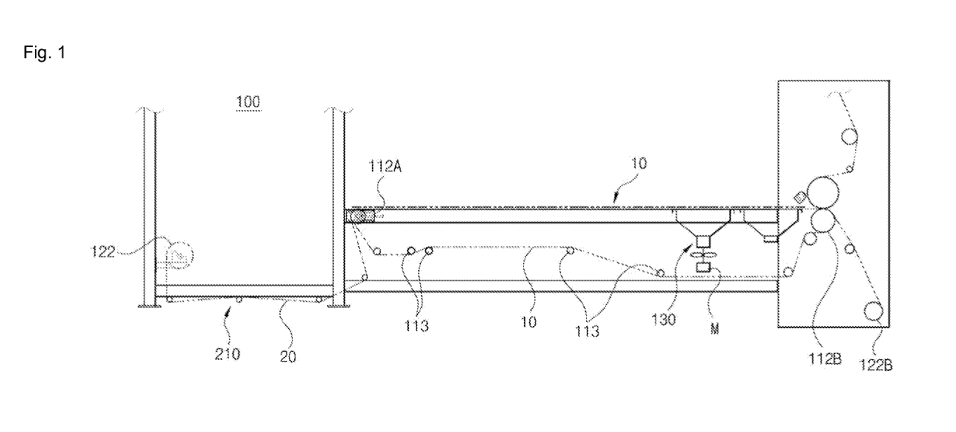

FIG. 1 is a lateral view illustrating a structure of a laminating apparatus 100 according to an embodiment of the present invention.

Referring to FIG. 1, the laminating apparatus 100 according to the current embodiment of the present invention includes a conveyor belt 10, an interleaving paper supply unit 120, an suction unit 130, and a sponge supply unit 140.

Also, a laminating method according to an embodiment of the present invention includes disposing an interleaving paper (operation S110), disposing an operation target (operation S120), taking air in (operation S130), driving a conveyor belt (operation S140), supplying a sponge (operation S150), and recovering (operation S160).

The components of the laminating apparatus 100 shown in FIG. 1 will now be described with reference to the laminating method.

The conveyor belt 10 moves to a location where a laminating operation is performed.

The conveyor belt 10 has a predetermined length and a predetermined width, and two ends of the conveyor belt 10 are connected to each other to form a caterpillar shape. A material of the conveyor belt 10 may include Teflon.

Transference of the conveyor belt 10 may be performed by first and second unit conveyor transfer rollers 112A and 1128.

The first and second unit conveyor transfer rollers 112A and 1128 are spaced apart from each other by a predetermined distance so that the conveyor belt 10 is tightly spread. At least one assistant roller 113 may be used to tightly spread the conveyor belt 10 and easily obtain a space for disposing components described later below the conveyor belt 10.

Here, a plurality of first through holes 12 having a predetermined diameter are formed on the conveyor belt 10. An interleaving paper 20 described later is adhered on the conveyer belt 10 as air is taken in through the first through holes 12 during an operation of the suction unit 130 described later, and thus a laminating operation is easily performed.

The interleaving paper 20 is disposed on the conveyor belt 10 in operation S110.

The interleaving paper 20 prevents a melt of a sponge 3 from being put on the conveyor belt 10 or a roller after the sponge 3 is melted by a heating unit 144 described later during a laminating operation performed on a genuine leather 1.

A width of the interleaving paper 20 may be equal to or larger than a width of the conveyor belt 10 so that the conveyor belt 10 is covered by the interleaving paper 20 while disposing the interleaving paper 20. However, if required, the width of the interleaving paper 20 may be smaller than the width of the conveyor belt 10.

The interleaving paper 20 includes a nonwoven fabric or vinyl having pores. The vinyl used as the interleaving paper 20 includes a plurality of second through holes 22 having uniform diameters.

When air is taken in through the first through holes 12, the second through holes 22 enable the air taken into the first through holes 12 to flow.

Here, a diameter of the second through hole 22 may be smaller than a diameter of the first through hole 12. Also, a separation distance between the second through holes 22 may be smaller than a separation distance between the first through holes 12.

Fibers forming the nonwoven fabric used as the interleaving paper 20 may not be stained with the melt of the sponge 3, and a sponge adhesion preventing layer may be formed on the interleaving paper 20 so that the melt is easily removed if the fibers are stained with the melt.

The interleaving paper 20 is supplied by an interleaving paper supply roller 122A, and the interleaving paper 20 is recovered by an interleaving paper recovery roller 122B. The interleaving paper supply roller 122A and the interleaving paper recovery roller 122B may be spaced apart from each other by a predetermined distance.

The interleaving paper supply roller 122A and the interleaving paper recovery roller 122B are spaced apart from each other by the predetermined distance. The interleaving paper 20 to be supplied is rolled around the interleaving paper supply roller 122A, and the interleaving paper recovery roller 122B recovers the interleaving paper 20 that has been used during the laminating operation. At this time, the interleaving paper recovery roller 122B may simultaneously recover an operation target 1 and the sponge 3 described later.

A laminating operation target is disposed on the interleaving paper 20 in operation S120. Here, the operation target that requires the laminating operation varies, but in the current embodiment a genuine leather having an irregular size and an irregular shape is described as the operation target. Thus, the same reference numeral is used for the genuine leather and the operation target.

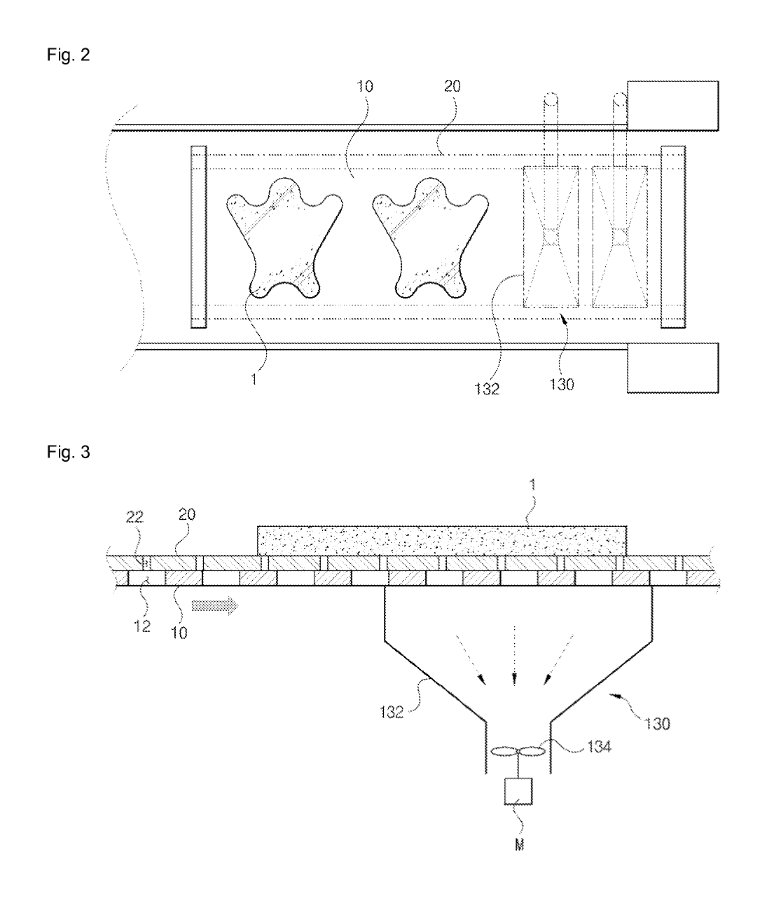

FIG. 2 is a view of genuine leathers 1 disposed on the conveyor belt 10, according is to an embodiment of the present invention. Referring to FIG. 2, a user may dispose the interleaving paper 20 on the conveyor belt 10, and the genuine leathers 1 on the interleaving paper 20 at regular intervals. Here, the regular intervals of the genuine leathers 1 may be as narrow as possible.

FIG. 3 is a view illustrating a structure of the suction unit 130 of FIG. 1.

Referring to FIG. 3, the suction unit 130 takes in air through the conveyor belt 10 (operation S130). In other words, the suction unit 130 takes air in through the first through hole 12 of the conveyor belt 10 such that the genuine leather 1 is adhered to the conveyor belt 10.

The suction unit 130 includes a hopper 132, an air intake fan 134, and a motor M.

The hopper 132 has a funnel shape, wherein an inlet is adhered to a bottom surface of the conveyor belt 10. The inlet of the hopper 132 may have a rectangular shape so that the genuine leather 1 is uniformly adhered on the conveyor belt 10. Here, a length of a long side of the inlet of the hopper 132, i.e., a width of the hopper 132 may correspond to a width of the conveyor belt 10. Also, a length of a short side of the inlet of the hopper 132 may vary according to the need of a user.

Also, if an area of the genuine leather disposed on the conveyor belt 10 is larger than an area of the inlet of single hopper 132, a plurality of the hoppers 132 may be continuously disposed to correspond to the genuine leather 1.

The motor M operates the air intake fan 134 according to manipulation of the user.

Outer air is taken in through the second through hole 22 of the interleaving paper 20, the first through hole 12 on the conveyor belt 10, and the hopper 132, according to rotation of the air intake fan 134.

The sponge supply unit 140 supplies a sponge to the genuine leather 1 to be laminated (operation S140. Here, the supplied sponge is a sponge having a melted surface.

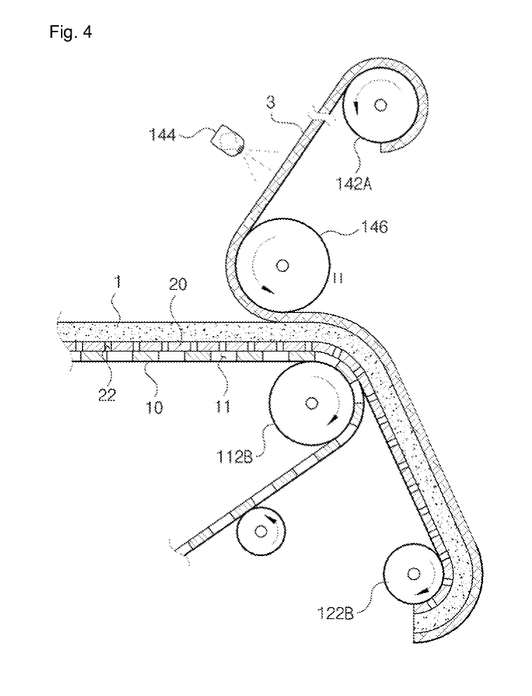

FIG. 4 is a view illustrating a structure of the sponge supply unit 140 of FIG. 1.

Referring to FIG. 4, the sponge supply unit 140 includes a sponge supply roller 142A, the heating unit 144, and a pressurizing roller 146.

The sponge supply roller 142A supplies the sponge 3 having a predetermined length, width, and thickness. Here, the width of the supplied sponge 3 may be large enough to cover the genuine leather 1 that is an operation target.

The heating unit 144 applies predetermined heat to the sponge 3 supplied from the sponge supply roller 142A to melt the surface of the sponge 3.

A width of the heating unit 144 may correspond to the width of the sponge 3 so that the sponge 3 is uniformly heated throughout the surface of the sponge 3.

The heating unit 144 may include a gas heater or an electric heater. However, any one of various heating units, such as an infrared lamp, may be used as the heating unit 144, as long as predetermined heat is applied to the sponge 3.

The sponge 3 heated by the heating unit 144 is not completely melted, and only the surface of the sponge 3 is melted.

In order to prevent the sponge 3 having the melted surface from being solidified before being adhered to the genuine leather 1, the heating unit 144 may be disposed close to the sponge 3 and the interleaving paper 20 within a range that the genuine leather 1 that is an operation target is not damaged by heat.

The pressurizing roller 146 pressurizes the sponge 3 having the melted surface to adhere to the genuine leather 1 through the second through hole 22. The pressurizing roller 146 adheres the sponge 3 to the genuine leather 1.

The pressurizing roller 146 may be disposed on the second unit conveyor transfer roller 1128 used to move the conveyor belt 10.

The length of the pressurizing roller 146 may be longer than the second unit conveyor transfer roller 1128 so that the genuine leather 1 is uniformly pressurized.

The sponge 3, the genuine leather 1, and the interleaving paper 20, which are pressurized by the pressurizing roller 146, may be recovered and stored for further operations.

The surface of the genuine leather 1 disposed on the interleaving paper 20 may be laminated by contacting the sponge 3 pressurized by the pressurizing roller 146. Since a region of the interleaving paper 20 where the genuine leather 1 is not located is not pressurized by the pressurizing roller 146, the sponge 3 is not stained on a surface of the region. The sponge 3 may be stained on a partial surface of the interleaving paper 20, but is not pressurized by the pressurizing roller 146, and thus the sponge 3 may be prevented from being stained on the conveyor belt 10 since the sponge 3 does not pass through the is second through hole 22.

After such a laminating operation, the operation target 1, the sponge 3, and the interleaving paper 20 are recovered by the interleaving paper recovery roller 122B. The operation target 1, the sponge 3, and the interleaving paper 20, which are recovered, are stored for future operations. The sponge 3 stained on the interleaving paper 20 is removed via a separate following operation.

According to the embodiments of the present invention, laminating may be performed on a material having an irregular standard, such as an irregular area or an irregular shape, like a genuine leather, and a melted sponge may be prevented from being adhered to a laminating roller during a laminating process. Also, laminating may be performed on a material having an irregular standard and a material having a regular standard, by using a same apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A laminating apparatus comprising:
a conveyor belt where a plurality of first through holes are formed;
an interleaving paper supply unit comprising an interleaving paper supply roller for supplying an interleaving paper and an interleaving paper recovery roller for recovering the interleaving paper, and disposing the interleaving paper on the conveyor belt;
an suction unit taking air in through the plurality of first through holes; and
a sponge supply unit supplying a sponge to an operation target on the conveyor belt,
wherein a laminating operation target is disposed on the interleaving paper.

2. The laminating apparatus of claim 1, wherein the interleaving paper is a nonwoven fabric or a vinyl tape including a plurality of second through holes.

3. The laminating apparatus of claim 2, wherein diameters of the plurality of second through holes are smaller than diameters of the plurality of first through holes.

4. The laminating apparatus of claim 2, wherein a separation distance between the plurality of second through holes is smaller than a separation distance between the plurality of first through holes.

5. The laminating apparatus of claim 1, wherein the suction unit comprises:
an air intake fan;
a motor operating the air intake fan; and
a hopper closely disposed to a bottom surface of the conveyor belt so that air intake through the air intake fan is easily performed.

6. The laminating apparatus of claim 5, wherein a width of an inlet of the hopper corresponds to a width of the conveyor belt.

7. The laminating apparatus of claim 1, wherein the sponge supply unit comprises:
a sponge supply roller supplying the sponge and recovering the sponge that has been used;
a heating unit supplying heat to the sponge so that a surface of the sponge is melted; and
a pressurizing roller adhering the sponge having the melted surface to the operation target.

8. The laminating apparatus of claim 7, wherein the supplied sponge is recovered by the interleaving paper recovery roller.

9. A laminating method comprising:
disposing an interleaving paper on a conveyor belt;
disposing a laminating operation target on the interleaving paper;
taking air in so that the laminating operation target, the interleaving paper, and the conveyor belt are adhered to each other;
driving the conveyor belt;
melting a part of a sponge and laminating the laminating operation target by supplying the melted part of the sponge to a surface of the laminating operation target; and
recovering each of the interleaving paper, an un-melted part of the sponge, and the laminated operation target.
